(19) United States
(12) Patent Application Publication
(10) Pub. No.: US 2010/0332841 A1
(43) Pub. Date: Dec. 30, 2010

(54) Authentication Method and System

(75) Inventors: Jude Anthony Watts, Reading (GB); Mathew Charles Buxton, Nottinghamshire (GB)

Correspondence Address: TED SABETY, c/o Sabety +associates, PLLC, 1130 Bedford Rd., PLEASANTVILLE, NY, 10570, US

(73) Assignee: VIERFIRE SOFTWARE LTD., New York, NY (US)

(21) Appl. No.: 12/822,078

(22) Filed: Jun. 23, 2010

(30) Foreign Application Priority Data
Jun. 24, 2009 (GB) GB0910897.8

(51) Int. Cl. H04L 9/32

(52) U.S. Cl. 713/182; 726/3

(57) ABSTRACT

Disclosed are methods related to controlling user access to a first computer device, using a second computer device. One method comprises generating authentication data in accordance with a first algorithm and generating acceptable response data in accordance with a second algorithm using the authentication data and information shared with a second computer device. The authentication data is received at the second computer device, where response data is generated in accordance with the second algorithm using the shared information and the received authentication data. The response data generated by the second device is received at the first computer device and compared with the acceptable response data. Access to the first computer device is granted if the response data is identical to the acceptable response data.

### PRIORITY CLAIM

This continuation patent application hereby incorporates by reference and claims priority as a continuation under 35 U.S.C. 119 to GB Patent Application No. GB0910897.8 filed on Jun. 24, 2009.

### SUMMARY OF THE INVENTION

This invention relates to a method for controlling access to a computer device. It also relates to a system on which the method may be performed and a computer program which causes the method to be performed when executed on a suitable computer.

Establishing the authenticity of a user who requests access to a computer system is of prime importance. This is especially true when the computer system comprises or has access to a repository of information, such as a database, which often contains sensitive, confidential, privileged or restricted information, such as banking records, information of a personal nature, or authentication details to allow an authorized user to access other computer systems or databases. Attacks on computer systems connected to the Internet are particularly common and easy to orchestrate. Owners or maintainers of such computer systems therefore normally ensure that the system is able to limit or prevent unauthorized access to the computer systems.

A user who wishes to gain access to a computer system may be challenged to provide their identity as a known and approved username. This username is normally associated with a password or passphrase, the composition of which is known to only those who are permitted to have such knowledge. It is common, however, for an approved user to have an easily guessed username and/or to have selected or been given a password or passphrase based on a dictionary word. This results in a weakened authentication system because it is susceptible to attacks. If an attack is successful then unauthorized and even malicious access to the computer system and thereby information stored on a connected database may be possible.

A username or password may be intercepted when entered into a terminal by a user seeking access to a computer system or connected database. For example, as the user enters their username and password into form fields presented by the existing authentication system, a casual observer may notice which keys are being pressed on a keyboard, or which characters are being selected from a character map. Even more subtly, the terminal may be hosting key-logging software which, in recording every keystroke or action of the user, can capture the authentication information supplied by the user requesting access to a computer system or connected database. The authentication information so gathered can be used to access the computer system or connected databases.

Although some security systems permit the contents of login forms to be stored by the user in order to prevent key-logging software from being used to gather the details, the user must, at some point, enter authentication information into a form associated with the request to access a particular computer system or connected database. Also, the files in which these authentication credentials are stored may be accessible, even if they are in an encrypted form.

Alternatively, usernames and corresponding passwords may be deliberately revealed by an authentic user in an attempt to share a personal license to access the particular computer system or connected database with those who are unlicensed. Stolen authentication may likewise be revealed by a thief or their agent. Thus, commercially valuable material which is stored on a database and should be accessed only by paid-up account holders could become available to those who have not paid for access to such valuable material. It is possible that usernames and their corresponding password for authentic accounts could be publicly posted on an open webpage, and this fact may remain unknown to the licensor for some time. As a result, much commercial harm may have been caused until the security leak is discovered and the compromised accounts suspended and/or the associated login credentials changed.

In some cases, a user's username and password do not expire and are associated with the account until the account is closed. However, it is also well known in the art that a username and associated password expire after a predetermined length of time and a user is required to be issued with or to choose a new password on a regular basis. Where there is a frequent change of password, the user must remember the new password, which may be difficult for the user to remember if it is a random combination of letters and numbers (this representing a more secure form of password as it is not easily cracked in a brute force attack). Alternatively, a user may merely cycle through a list of passwords, reducing the security of the authentication system over time.

To prevent malicious access to an account which has been “sniffed” by an automated process (for example, where malicious software employs a list of known personal information about a user, such as e-mail addresses, names and variation of names), authentication systems of the art sometimes require an input which distinguishes the process from a human. Thus, where an authentication system presents a form requiring an e-mail address as a username and a password, the authentication system may also present a dynamically-generated distorted image of a word or random combination of alphanumeric characters, for example using the Captcha system. The user is expected to enter the word or characters shown in the distorted image into a form field in response.

The image is so designed that a machine cannot interpret the characters, and thus only a human can respond to this challenge by the authentication system. Of course, any malicious user who has gained an authentic user's username and password from, for example, a web-page or by looking over their shoulder, can interpret the distorted image and provide a valid response to the challenge. The authentication system is not therefore secure to malicious users. Furthermore, the system cannot be used by the visually impaired.

It is desirable therefore for an authentication system to provide a further degree of security which reduces the risk of interception during transmission to and/or from a protected computer system or connected database, or to interception by key-logging or casual observation of a user input, or to deliberate posting on a public website.

In order to improve the authentication techniques mentioned above, a user may be provided with accessories or statistical data may be gathered about the user's behaviour.

U.S. Pat. No. 6,983,882 teaches an authentication device which takes biometric information from a user to be authenticated and compares the information so taken to reference information for that user. The authentication is unique to the individual being authenticated, but cannot easily be provided for a group or team and is subject to problems with the consistency with which biometric information can be gathered.

European patent 1308909 teaches an authentication means where a terminal receives a radio signal which is varied with time. The radio signal provides seed data for the generation of a pseudo-random number from which a signature can be produced. The same radio signal is received by a computer system to be accessed so that the expected signature can be generated by the computer system for comparison with the signature generated by the terminal. If there is a match then access is granted. The terminal is used in conjunction with a card carrying a chip which includes a processor programmed with the algorithm for generating the signature.

European patent 1843272 discloses a dongle for connection to a portable terminal, wherein the result of such connection is a code presented by the terminal to a user to enable the user to complete an authentication session for a transaction with a banking service. The provision of dedicated terminals and dongles is costly and often inconvenient to the user, who must ensure these uncommon accessories are to hand when embarking on an authentication session.

United States patent application 2008/0162338 teaches the monitoring of online session statistics such as IP address, browser ID, hour of day and time since the user's last valid login. A measure of improbability is calculated based on these factors and access is granted if the measure of improbability exceeds a threshold. A user attempting to seek authentication from a remote site that they do not normally use could be denied access when it should be allowed when using this system.

Each of the prior art techniques discussed above suffers from one of a variety of problems. Some are too easy for a hacker to defeat (for example the single factor authentication techniques), some are more secure but are too cumbersome and difficult to use, some are prone to deny access to valid users and some require expensive equipment in order to make use of them.

According to a first aspect of the present invention, there is provided a method of controlling access to a first computer device, typically a server, the method comprising: generating authentication data that comprises a challenge data object in accordance with a first algorithm; generating acceptable response data in accordance with a second algorithm using the authentication data or challenge data object and unique identifying information shared with a second computer device; receiving the authentication data at the second computer device; generating, at the second computer device, response data in accordance with the second algorithm using the shared unique identifying information and the received authentication data or challenge data object; receiving the response data generated by the second device; comparing the response data with the acceptable response data; and granting access to the first computer device if the response data is identical to the acceptable response data.

The invention overcomes the problems presented by the prior art by introducing a second factor to the authentication process which is easily made use of by way of readily available computing equipment such as a suitably programmed mobile phone or personal digital assistant (PDA). This can be used as the second computer device. Such devices are now almost ubiquitous in the developed world and modern mobile phones can have suitable application software downloaded to them from the Internet. The invention therefore dramatically increases the level of security offered by an authentication process without introducing much additional burden on users and at little or no extra cost.

According to a second aspect of the present invention, there is provided a method of controlling access to a first computer device, the method comprising: generating authentication data in accordance with a first algorithm; generating acceptable response data in accordance with a second algorithm using the authentication data and information shared with a second computer device; receiving response data generated by the second computer device; comparing the response data with the acceptable response data; and granting access to the first computer device if the response data is identical to the acceptable response data.

Typically in these first and second aspects, the first computer device performs at least one of the following steps: generating authentication data in accordance with a first algorithm; generating acceptable response data in accordance with a second algorithm using the authentication data and information shared with a second computer device; receiving the response data generated by the second device; comparing the response data with the acceptable response data; and granting access to the first computer device if the response data is identical to the acceptable response data.

Generating acceptable response data may be performed after receiving the response data generated by the second device.

The response data may be received via a wireless communications link.

Receiving the response data may comprise receiving a Short Message Service ‘SMS message or an e-mail containing the response data.

According to a third aspect of the present invention, there is provided a method of generating response data at a second computer device for use in controlling access to a first computer device, the method comprising: receiving at the second computer device authentication data generated at a remote device in accordance with a first algorithm; and in response to receipt of the authentication data, using the authentication data and predetermined information shared with the remote device to generate response data in accordance with a second algorithm.

Typically in this third aspect, the remote device is the first computer device.

Typically, in the first and third aspects receiving the authentication data at the second computer device comprises capturing with a camera an image in which the authentication data is embedded. Preferably, the image is a two-dimensional barcode.

Alternatively the image may be configured for computer visual display units (VDU) and use one or more of chrominance, luminance and position within the image of a VDU pixel or group of pixels to represent the authentication data. The complexity of the image is determined by the resolution of the VDU and an image resolution the camera can reliably capture.

As another alternative, in the first and third aspects receiving the authentication data at the second computer device comprises receiving a sound or a sequence of sounds through a microphone.

As a further alternative, in the first and third aspects receiving the authentication data at the second computer device comprises receiving the authentication data via a wireless communications link e.g. Bluetooth, WiFi etc.

In another alternative in the first and third aspects, receiving the authentication data at the second computer device comprises receiving a user input (e.g. using a keypad) including the authentication data.

Alternatively in the first and third aspects, receiving the authentication data at the second computer device comprises receiving a Short Message Service ‘SMS’ message or an e-mail containing the authentication data.

Typically, in any of these three aspects, the shared information comprises an identifier, or a representation/derivation thereof, unique to the second device such as International Mobile Equipment Identity ‘IMEI’ or an International Mobile Subscriber Identity ‘IMSI’.

In accordance with a fourth aspect, there is provided a system for controlling access to a first computer device, the system comprising: a processor adapted to perform the steps of the method of the second aspect described above; and/or a processor adapted to perform the steps of the method of the third aspect described above.

In accordance with a fifth aspect, there is provided a computer program comprising computer-implementable instructions, which when executed by a programmable computer: causes the programmable computer to perform the method of the second aspect described above.

In accordance with a sixth aspect, there is provided a computer program comprising computer-implementable instructions, which when executed by a programmable computer: causes the programmable computer to perform the method of the third aspect described above.

In accordance with a seventh aspect, there is provided a computer program product comprising a computer program, which when executed by a programmable computer: causes the programmable computer to perform the method of the second aspect described above.

In accordance with an eighth aspect, there is provided a computer program product comprising a computer program, which when executed by a programmable computer: causes the programmable computer to perform the method of the third aspect described above.

According to a ninth aspect of the present invention, there is provided a method of controlling access to a first computer device, the method comprising: generating, from seed data, authentication data in accordance with a first algorithm using information shared with a second computer device; receiving the authentication data at the second computer device; generating, at the second computer device, response data in accordance with a second algorithm using the shared information and the received authentication data; receiving the response data generated by the second device; comparing, at the first computer device, the response data with the seed data; and granting access to the first computer device if the response data is identical to the seed data.

According to a tenth aspect of the present invention, there is provided a method of controlling access to a first computer device, the method comprising: generating, from seed data, authentication data in accordance with a first algorithm using information shared with a second computer device; receiving response data originating from the second device; and comparing the response data with the seed data; and granting access to the first computer device if the response data is identical to the seed data.

Typically, in accordance with these ninth or tenth aspects, receiving the response data comprises receiving the response data via a wireless communications link.

Receiving the response data may comprise receiving a Short Message Service ‘SMS’ message or an e-mail containing the response data.

According to an eleventh aspect of the present invention, there is provided a method of generating response data at a second computer device for use in controlling access to a first computer device, the method comprising: receiving at the second computer device authentication data generated at a remote device in accordance with a first algorithm using information shared with the second computer device; and in response to receipt of the authentication data, using the authentication data and the shared information to generate response data in accordance with a second algorithm.

Typically, in accordance with this eleventh aspect, the remote device is the first computer device.

Preferably, in the ninth or eleventh aspects, receiving the authentication data at the second computer device comprises capturing with a camera an image in which the authentication data is embedded. More preferably, the image is a two-dimensional barcode. Alternatively, the image may be configured for computer visual display units (VDU) and use one or more of chrominance, luminance and position within the image of a VDU pixel or group of pixels to represent the authentication data. The complexity of the image is determined by the resolution of the VDU and an image resolution the camera can reliably capture.

Alternatively in the ninth or eleventh aspects, receiving the authentication data at the second computer device comprises receiving a sound or a sequence of sounds through a microphone.

As another alternative in the ninth or eleventh aspects, receiving the authentication data at the second computer device comprises receiving the authentication data via a wireless communications link e.g. Bluetooth or WiFi.

As a further alternative in the ninth or eleventh aspects, receiving the authentication data at the second computer device comprises receiving a user input (e.g. using a keypad) including the authentication data.

As a yet further alternative in the ninth or eleventh aspects, receiving the authentication data at the second computer device comprises receiving a Short Message Service ‘SMS’ message or an e-mail containing the authentication data.

Typically, in the ninth or eleventh aspects the first and second algorithms comprise mutually inverse algorithms.

Preferably, the first algorithm is a symmetric encryption algorithm; the second algorithm is a symmetric decryption algorithm corresponding to the first algorithm; and the shared secret information comprises a predetermined private key for use by the first and second algorithms. For example, the first and second algorithms may be the encryption and decryption algorithms, respectively, defined in the Advanced Encryption Standard (AES). The shared secret information may comprise a predetermined private key that is, or is derived from, an International Mobile Equipment Identity ‘IMEI’ or an International Mobile Subscriber Identity ‘IMSI’.

Alternatively, the first algorithm is an asymmetric encryption algorithm; the second algorithm is an asymmetric decryption algorithm corresponding to the first algorithm; and the shared information comprises a predetermined public/private key pair, the predetermined public key for use by the encryption algorithm and the predetermined private key for use by the decryption algorithm. For example, the first and second algorithms may be the encryption and decryption parts, respectively, of the RSA encryption algorithm. The shared secret information may comprise a predetermined private/public key pair that is derived from an International Mobile Equipment Identity ‘IMEI’ or an International Mobile Subscriber Identity ‘IMSI’.

Typically, in any of the ninth, tenth or eleventh aspects, the seed data comprises a Unix timestamp, a pseudorandom number, a randomly-selected character from the user input or the like.

According to a twelfth aspect of the present invention, there is provided a system for controlling access to a first computer device, the system comprising: a processor adapted to perform the steps of the method of the ninth or tenth aspects described above; and/or a processor adapted to perform the steps of the method of the eleventh aspect described above.

According to a thirteenth aspect of the present invention, there is provided a computer program comprising computer-implementable instructions, which when executed by a programmable computer: causes the programmable computer to perform the method of the tenth aspect described above.

According to a fourteenth aspect of the present invention, there is provided a computer program comprising computer-implementable instructions, which when executed by a programmable computer: causes the programmable computer to perform the method of the eleventh aspect described above.

According to a fifteenth aspect of the present invention, there is provided a computer program product comprising a computer program, which when executed by a programmable computer: causes the programmable computer to perform the method of the tenth aspect described above.

According to a sixteenth aspect of the present invention, there is provided a computer program product comprising a computer program, which when executed by a programmable computer: causes the programmable computer to perform the method of the eleventh aspect described above.

According to a seventeenth aspect of the present invention, there is provided a method of controlling access to a first computer device, the method comprising: generating, from seed data, authentication data in accordance with a first algorithm; receiving the authentication data at the second computer device; generating, at the second computer device, response data in accordance with a second algorithm using information shared with the first computer device and the received authentication data; and receiving the response data generated by the second device; verifying, using the received response data and the shared information, that the response data was generated by the second device; and granting access to the first computer device if it is verified that the second device generated the response data.

According to an eighteenth aspect of the present invention, there is provided a method of controlling access to a first computer device, the method comprising: generating, from seed data, authentication data in accordance with a first algorithm; receiving response data generated by a second device; verifying, using the received response data and information shared with the second device, that the response data was generated by the second device; and granting access to the first computer device if it is verified that the second device generated the response data.

Typically, in the seventeenth and eighteenth aspects receiving the response data comprises receiving the response data via a wireless communications link e.g. via Bluetooth or WiFi.

Alternatively, receiving the response data comprises receiving a Short Message Service ‘SMS’ message or an e-mail containing the response data.

According to a nineteenth aspect of the present invention, there is provided a method of generating response data at a second computer device for use in controlling access to a first computer device, the method comprising: receiving at the second computer device authentication data generated at a remote device in accordance with a first algorithm using information shared with the second computer device; and in response to receipt of the authentication data, using the authentication data and the shared information to digitally sign the authentication data, or a derivative thereof, using a digital signature algorithm. For example, the digital signature algorithm may be a signature algorithm in accordance with the Digital Signature Algorithm (DSA) standard, or equivalent such as the elliptic curve digital signature algorithm (ECDSA). Similarly, verifying that the response data was generated by the second device may be performed by a verification algorithm in accordance with the Digital Signature Algorithm (DSA) standard, or equivalent such as the elliptic curve digital signature algorithm (ECDSA).

Typically, in the seventeenth or nineteenth aspects receiving the authentication data at the second computer device comprises capturing with a camera an image in which the authentication data is embedded. Preferably, the image is a two-dimensional barcode. Alternatively, the image may be configured for computer visual display units (VDU) and use one or more of chrominance, luminance and position within the image of a VDU pixelor group of pixels to represent the authentication data. The complexity of the image is determined by the resolution of the VDU and an image resolution the camera can reliably capture.

Alternatively, in the seventeenth or nineteenth aspects, receiving the authentication data at the second computer device comprises receiving a sound or a sequence of sounds through a microphone.

Typically, in the seventeenth or nineteenth aspects, receiving the authentication data at the second computer device comprises receiving the authentication data via a wireless communications link e.g. via Bluetooth or WiFi.

Alternatively, in the seventeenth or nineteenth aspects, receiving the authentication data at the second computer device comprises receiving a user input (e.g. using a keypad) including the authentication data.

As a further alternative, receiving the authentication data at the second computer device comprises receiving a Short Message Service ‘SMS’ message or an e-mail containing the authentication data.

Preferably, in accordance with the seventeenth, eighteenth or nineteenth aspects, the shared information comprises a public key pair that is based on, or is derived from, an International Mobile Equipment Identity ‘IMEI’ or an International Mobile Subscriber Identity ‘IMSI’.

According to a twentieth aspect of the present invention, there is provided a system for controlling access to a first computer device, the system comprising: a processor adapted to perform the steps of the method of the eighteenth aspect described above; and/or a processor adapted to perform the steps of the method of the nineteenth aspect described above.

According to a twenty-first aspect of the present invention, there is provided a computer program comprising computer-implementable instructions, which when executed by a programmable computer: causes the programmable computer to perform the method of the eighteenth aspect described above.

According to a twenty-second aspect of the present invention, there is provided a computer program comprising computer-implementable instructions, which when executed by a programmable computer: causes the programmable computer to perform the method of the nineteenth aspect described above.

According to a twenty-third aspect of the present invention, there is provided a computer program product comprising a computer program, which when executed by a programmable computer: causes the programmable computer to perform the method of the eighteenth aspect described above.

According to a twenty-fourth aspect of the present invention, there is provided a computer program product comprising a computer program, which when executed by a programmable computer: causes the programmable computer to perform the method of the nineteenth aspect described above.

According to a further aspect of the invention there is provided a method of retrieving authentication data from an image, the method comprising:

receiving at the second computer device authentication data generated at a remote device;
in response to receipt of the authentication data, using the authentication data and predetermined information shared with the remote device to generate response data in accordance with an algorithm;
the algorithm being first generated by the remote device and the second computer device according to the predetermined information shared with the remote device;
a value of the algorithm being stored; and
the value of the algorithm being used as a seed value for generating a new algorithm for use with the authentication data in response to subsequent receipt of authentication data to generate response data.

The Authentication Image could take the form of a ‘normal image’ with the information encoded at specific points or locations. Either by subtle manipulation of the image to provide the needed data at static points or by using an unaltered image and calculating the points or locations to read from the image. Specific data in the challenge data object is thereby extracted at the specified locations. Thus, a logo or subtly-altered logo could be used as an Authentication Image form of a challenge data object.

The co-ordinates or locations of the points relevant to the calculations for the first, manipulated image will be pre-shared between client and server applications. For the second instance, the co-ordinates may be calculated by performing a function on some mutually shared, but changing data on such data values comprising the first set of co-ordinates or locations

One method of this would be to calculate the first (and only the first) set of co-ordinates from the unique identifier of the device and store this at both the server and client sides. Each subsequent set of co-ordinates would then be calculated by passing the previous co-ordinates to a mathematical function as a seed value.

With the same functions and the same seed values, the client and server applications will derive the same co-ordinates without any need for communicating. This method is very similar to how the values attained by parsing the information at these points is then used as the seed for a common algorithm.

The base value for the co-ordinates will be calculated in the same way as for the standard, grid-based ‘barcode’ style images. There must be detectable ways to discover size and orientation of the image for this to be effective, which are described further herein.

### BRIEF DESCRIPTION OF THE DRAWINGS

Other aspects and advantages of the present invention will be appreciated from the following description of exemplary embodiments with reference to the accompanying drawings, in which:

FIG. 1 depicts a high level view of an authentication system according to a preferred embodiment of the present invention;

FIG. 2 is a flow chart showing the steps of an authentication method according to a first embodiment of the invention;

FIG. 3 is a flow chart showing the steps of an authentication method according to a second embodiment of the invention; and

FIG. 4 is a flow chart showing the steps of an authentication method according to a third embodiment of the invention.

### DETAILED DESCRIPTION OF THE PREFERRED EMBODIMENTS

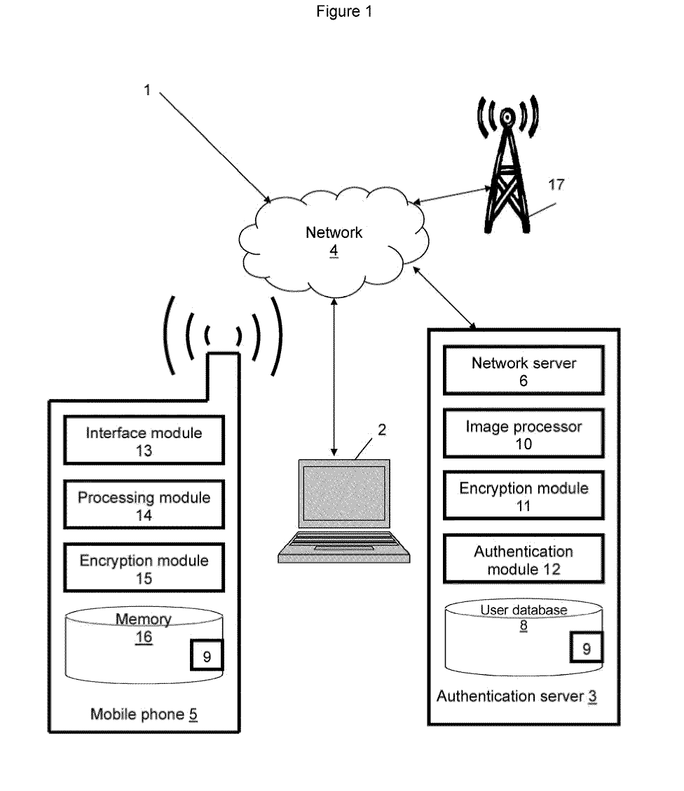

Referring first to FIG. 1, there is shown an authentication system 1 in accordance with an embodiment of the present invention. The authentication system 1 comprises a user terminal 2 and an authentication server 3, each connected to a network 4, and a mobile phone 5 that can be communicably linked to the user terminal 2 and/or the network 4. The network may comprise the Internet and/or one or more of: a personal area network (PAN); a local area network (LAN); and a wide area network (WAN).

The user terminal 2 comprises an internet browser through which a user may interact with the terminal 2 to communicate with the authentication server 3 over the network 4. These communications will be made over a secure channel using HyperText Transfer Protocol Secure (HTTPS) or the like. Thus, a user may use the Internet browser, in conjunction with his mobile phone 5 as will be described later, to authenticate himself to the authentication server 3 and gain access to secure services.

The authentication server 3 shown in FIG. 1 comprises a network server 6, an application server 7 and a user database 8. The network server 6 is a conventional server that enables the authentication server 3 to communicate over the network 4 with the user terminal 2 and other network devices connected thereto, using known network 25 communication protocols e.g. TCP/IP. The user database 8 has stored therein a number of records, each corresponding to a respective user registered on the authentication server 3 as required by the authentication system 1. Each record comprises a number of items of information corresponding to a particular user registered on the authentication server 3, the items including a username or e-mail address, password and shared information 9 corresponding to the particular registered user's mobile phone 5.

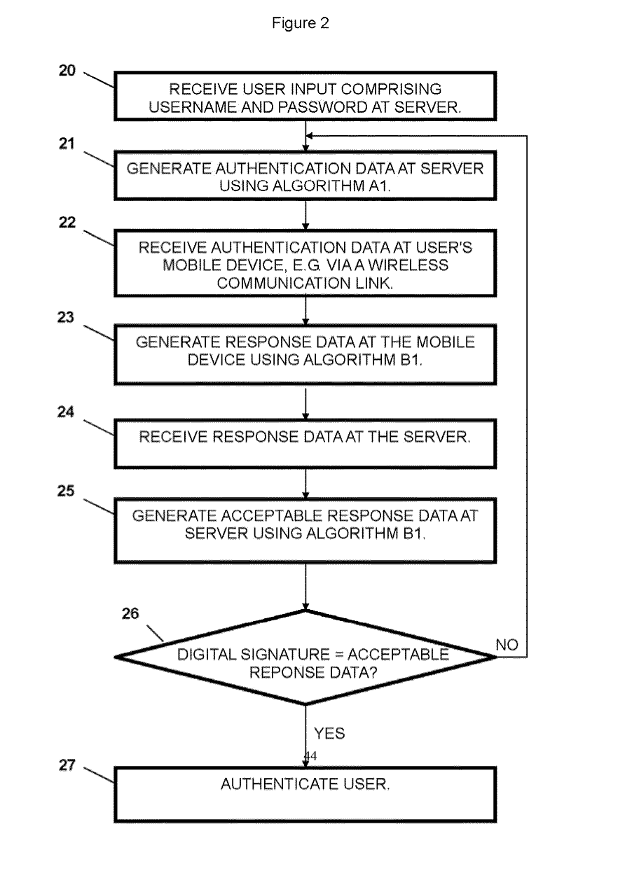

The application server 7 further comprises, for performing authentication methods in accordance with the present invention, an image processor 10, an encryption module 11 and an authentication module 12. Each is operable to communicate with any one or more of the others, and their functionality will be described in more detail below with reference to FIGS. 2 to 4. The server software may be written in a language that allows dynamic content generation such as PHP, JSP, ASP.net, SSI, CGI, SCGI, FastCGI, or a server API such as NSAPI, ISAPI.

The mobile phone 5 shown in FIG. 1 comprises an interface module 13, a processing module 14, an encryption module 15 and memory 16, each of which is operable to communicate with any one or more of the others. The interface module 13 comprises conventional software that enables the mobile phone 5 to communicate with the user terminal 2 and/or connect to the network 4 via communications base station 17 or via a WiFi hub (not shown). Such communication can include, e.g., using known network communication protocols such as TCP/IP including sending and receiving e-mails, direct wired communications via a USB link or equivalent, wireless communication using Bluetooth or WiFi, and communication via Short Message Service (SMS) messages. The communication can also include capturing an image displayed e.g. on the user terminal's VDU using the mobile phone's 5 camera, or a camera attached thereto, and interpreting the captured image to extract information.

The mobile phone 5 uses, as will be described later with reference to FIGS. 2 to 4, the processing module 14, the encryption module 15 and memory 16 in authenticating its user to the authentication server 3.

Referring now to FIG. 2, there is shown a flowchart depicting the method steps performed in accordance with a first embodiment of the invention. It is noted that before the method steps shown in FIG. 2 are performed, the user referred to in the method steps has already been registered with the authentication server 3. As a result, the user's mobile phone 5 has been registered, and each of the user database 8 and the mobile phone's 5 memory 16 have stored therein corresponding shared information 9.

In this embodiment the shared information 9 comprises a derivative of the mobile phone's 5 International Mobile Equipment Identity (IMEI) number. Each of the user database 8 and the memory 16 also have stored therein the user's username or e-mail address and optionally one or more corresponding passwords.

In accordance with this first embodiment, the first step of the authentication method is to receive user input at the user terminal 2. The user input is entered via a user terminal's 2 keyboard and comprises a username or e-mail address, and optionally a password. The user input is then communicated to the authentication server 3 over the network 4. If the authentication server 3 determines that the user input is invalid, e.g. if it does not correspond correctly to a username or e-mail address in any of the records in the user database 8, the first step will be repeated.

If on the other hand the received user input is valid then the application server 7 generates 21 authentication data or challenge data object from seed data using Algorithm A1, the seed data preferably being generated in response to receiving 20 the user input by e.g. using a time value mixed with a representation of the received username or e-mail address and/or password (e.g. a representation using the ASCII values of the characters which make up the username or e-mail address and/or password). This mixing may be an arithmetic operation such as addition, a concatenation or a combination thereof. Thus the seed data and, consequently, the authentication data are each different at respective generation steps.

In this embodiment, to generate 21 the authentication data in accordance with Algorithm A1, the application server 7 forms an array of integers which contains the ASCII values of the first three characters of the username or e-mail address received 20 in the user input. The eighth digit is taken from a ten-digit UNIX timestamp and added to each integer in the array. A character string is formed by concatenating the hexadecimal representation of the first three values of the integer array. This character string is the authentication data that comprises challenge data object.

The authentication data may then be formatted by the network server 6 to be communicated to the user's mobile phone 5. Preferably, the authentication data is first formatted as a conventional 2D barcode by the image processor 10, and then packetized appropriately by the network server 6 to be communicated over the network 4 to the user terminal 2 to be displayed on its display. Alternatively, the authentication data may be packetized to be transferred either directly to the mobile phone 5 via, e.g., e-mail, SMS message or Bluetooth transfer. In another embodiment, the authentication data, or challenge data object, is sent to the user terminal 2 to be rendered, or displayed to the user, who then inputs the challenge data object into the mobile phone 5. The user can input the challenge data object by capturing a displayed image, capturing a sound, typing in alphanumeric text or otherwise actuating the user interface of the mobile phone.

The next step is to receive 22 the authentication data comprising the challenge data object at the mobile phone 5. The authentication data may be received 22 via the interface module 13, over the network 4, as an e-mail, as an SMS message, via Bluetooth or via a wired communication. In this embodiment, the authentication data is received via the interface module 13 by capturing, using the mobile phone's 5 camera or a camera linked thereto, the 2D barcode displayed on the display of the user terminal 2. The user can input the challenge data object by capturing a displayed image, capturing a sound, typing in alphanumeric text or otherwise actuating the user interface of the mobile phone. The authentication data is then derived from the 2D barcode by the processing module 14 in a conventional manner.

In response to receiving 22 the authentication data comprising the challenge data object, in the next method step the encryption module 15 generates 23 response data in accordance with Algorithm B1. In this embodiment, Algorithm B1 comprises the Advanced Encryption Standard (AES) and uses the derivative of the mobile phone's 5 IMEI number in the shared information 9 as the symmetric key with which to encrypt the received authentication data. Thus the response data generated 23 by the encryption module 15 is an encrypted version of the authentication data received 22 at the mobile phone 5.

More specifically, Algorithm B1 comprises the AES-128 cipher (the 128-bit key length version of the AES algorithm for encrypting plaintext) and uses as the 128-bit symmetric key the derivative of the mobile phone's 5 IMEI number in the shared information 9. This derivative is a 128-bit binary number derived from the IMEI number as follows. The binary representations of the ASCII values of the fourteen characters of the mobile phone's IMEI number are concatenated, with a zero between the binary representations of each character. The result is a 125-bit binary number, to which one leading and two trailing zeros are appended to produce the 128-bit derivative in the shared information. In this embodiment, Algorithm B1 includes the key generation algorithm to produce each of the round keys required by the AES algorithm. In alternative embodiments, the shared information 9 may comprise all of the round keys along with the derivative of the mobile phone's IMEI number. The response data generated by the encryption module 15 thus comprises the result of performing an AES-128 cipher operation on the received authentication data using as the 128-bit symmetric key the derivative of the mobile phone's IMEI number from the shared information 9. The response data may then be formatted by the processing module 14 before being communicated to the authentication server 3. In this embodiment, the response data is displayed on the mobile phone's 5 display, along with a prompt for the user to manually enter the response data at the user terminal 2. Alternatively, the authentication data may be passed from the processing module 14 to the interface module 13, then packetized to be transferred to the user terminal 2 via a wired or wireless link or communicated to the authentication server 3 over the network 4, in an e-mail, as an SMS message or the like.

Having generated the response data, the next method step is to receive 24 the response data at the authentication server 3. In this embodiment, the response data is manually entered at the user terminal 2 by the user, from where it is communicated to the authentication server 3 over the network 4. Alternatively, the authentication data may be transferred from the mobile phone 5 to the user terminal 2 via a wired or wireless link, or directly to the authentication server 3 as an SMS message or over the network 4 e.g. in an e-mail.

The method then proceeds, in response to receipt 24 of the response data, to generate 25 acceptable response data. In this embodiment, both the encryption module 15 on the user's mobile phone 5 and the encryption module 11 on the application server 7 can perform Algorithm B1 to produce identical results. Thus, the encryption module 11 generates 25 acceptable response data from the generated 21 authentication data using Algorithm B1. The acceptable response data is generated 25 according to steps identical to, or at least equivalent to, the steps described above with reference to generating 23 the response data at the mobile phone 5. In alternative embodiments the acceptable response data may be generated at any time after the authentication data has been generated, and not in response to receipt 24 of the response data.

The authentication module 12 then compares 26 the generated 25 acceptable response data with the received 24 response data, and if the two are identical the authentication server 3 authenticates 27 the user and grants access to the secure services. If the two are different, access is denied and the method is repeated from the point at which authentication server generates 21 authentication data.

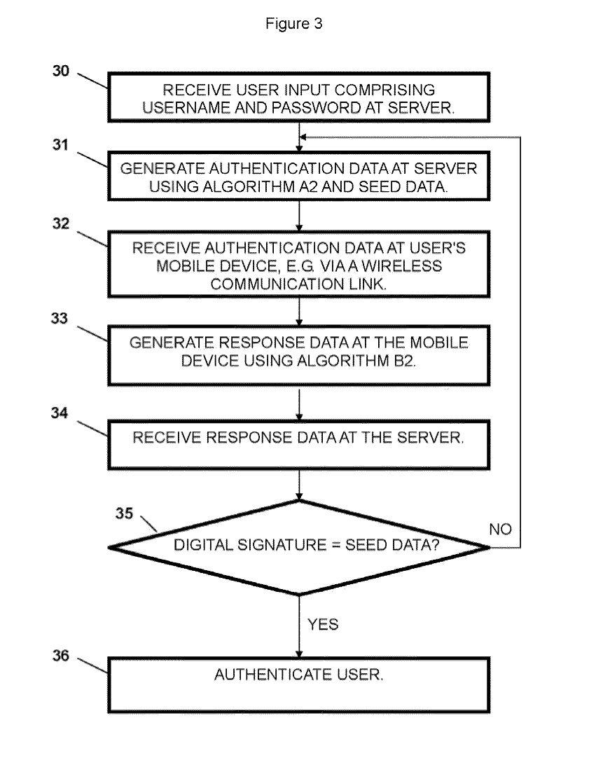

Referring now to FIG. 3, there is shown a flowchart depicting the method steps performed in accordance with a second embodiment of the invention. It is noted that before the method steps shown in FIG. 3 are performed, the user referred to in the method steps has already been registered with the authentication server 3. As a result, the user's mobile phone 5 has been registered, and each of the user database 8 and the mobile phone's 5 memory 16 have stored therein corresponding shared information 9. In this embodiment the shared information 9 comprises a derivative of the mobile phone's 5 International Mobile Equipment Identity (IMEI) number. Each of the user database 8 and the memory 16 also have stored therein the user's username or e-mail address and optionally one or more corresponding passwords.

As the first step of the method according to this embodiment, a user input is received 30 at the authentication server 3. This first step is equivalent to the first step of the method according to the first embodiment, and thus what the user input comprises and how it is received is the same as was described above with reference to the first step shown in FIG. 2. If the authentication server 3 determines that the user input is invalid, e.g. if it does not correspond correctly to any of the records in the user database 8, the first step will be repeated.

If on the other hand the received user input is valid then in the second step, application server 7 generates 31 authentication data from seed data in accordance with Algorithm A2, the seed data preferably corresponding to the received user input. This seed data is generated in response to receiving 20 user input by e.g. using a time value mixed with a representation of the username or e-mail address and/or password (e.g. a representation using the ASCII values of the characters which make up the username or e-mail address and/or password). This mixing may be an arithmetic operation such as addition, a concatenation or a combination thereof. Thus the seed data and, consequently, the authentication data are each different at respective generation steps.

In this embodiment, Algorithm A2 has a mutually inverse Algorithm B2, the algorithms comprising the cipher and the inverse cipher of the advanced encryption standard (AES) algorithm respectively.

In this embodiment, the application server 7 forms an array of integers which contains the ASCII values of the first three characters of the username or e-mail address received 20 in the user input. The eighth digit is taken from a ten-digit UNIX timestamp and combined with each integer in the array using an exclusive-or operation to produce the seed data. In order to generate 31 the authentication data, encryption module 11 performs on the integer array Algorithm A2, which comprises the AES-128 cipher (the 128-bit key length version of the AES algorithm for encrypting plaintext), and uses as the symmetric key the derivative of the mobile phone's 5 IMEI number in the shared information 9. This derivative is a 128-bit binary number derived from the IMEI number as was described above with reference to the first embodiment. In this embodiment, Algorithm A2 includes the key generation algorithm to produce each of the round keys required by the AES algorithm. In alternative embodiments, the shared information 9 may comprise all of the round keys along with the derivative of the mobile phone's IMEI number. The generated authentication data thus comprises the result of performing an AES-128 cipher operation on the integer array, generated from the seed data, using as the 128-bit symmetric key the derivative of the mobile phone's IMEI number from the shared information 9. The generated authentication data is then prepared for transmission as was described with reference to the first embodiment.

As the third step of the method according to this second embodiment, the generated authentication data is received 32 at the mobile phone 5. This step is equivalent to the third method step of the first embodiment, and thus how the authentication data is communicated from the authentication server 3 and received by the mobile phone 5 is the same as was described above with reference to the third step shown in FIG. 2.

In the next step, in response to receipt of the authentication data, the encryption module 15 generates 33 response data in accordance with Algorithm B2. In generating 33 the response data, the encryption module 15 uses Algorithm B2 and the derivative of the mobile phone's 5 IMEI number in the shared information 9 to derive the seed data from the received authentication data. More specifically, Algorithm B2 comprises the AES-128 inverse cipher (the 128-bit key length version of the AES algorithm for decrypting cipher text) and uses as the symmetric key the derivative of the mobile phone's 5 IMEI number in the shared information 9. This derivative is a 128-bit binary number derived from the IMEI number as was described above with reference to the first embodiment. In this embodiment, Algorithm B2 includes the key generation algorithm to produce each of the round keys required by the AES algorithm. In alternative embodiments, the shared information 9 may comprise all of the round keys along with the derivative of the mobile phone's IMEI number. The generated response data thus comprises the result of performing an AES-128 inverse cipher operation on the received authentication data using as the 128-bit symmetric key the derivative of the mobile phone's 5 IMEI number from the shared information 9.

The authentication server 3 then receives, in the next method step, the generated 31 response data. This step is equivalent to the fifth step of the method according to the first embodiment, and thus how the response data is communicated from the mobile phone 5 and received by the authentication server 5 is the same as was described above with reference to the fifth step shown in FIG. 2. It is noted that the step of generating acceptable response data is obviated in this embodiment, because the received response data should comprise the seed data from which the authentication data was generated.

At the penultimate method step of the second embodiment, the authentication module 12 compares 35 the response data with the seed data from which the authentication data was generated. If the two are identical the authentication server 3 authenticates 36 the user and grants access to the secure services; otherwise access is denied and the method is repeated from the point at which the application server 7 generates 31 authentication data.

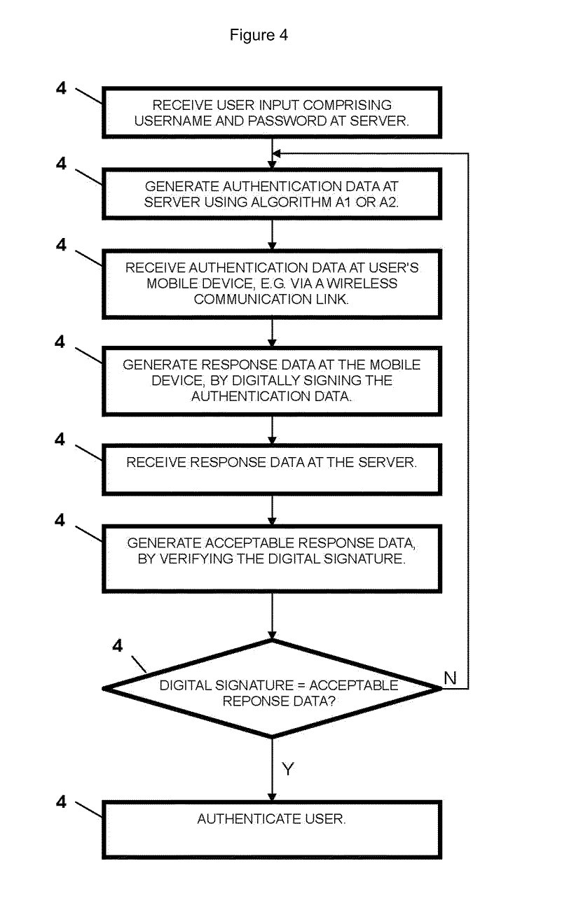

FIG. 4 shows a flowchart depicting the method steps performed in accordance with a third embodiment of the invention. It is noted that before the method steps shown in FIG. 4 are performed, the user referred to in the method steps has already been registered with the authentication server 3. As a result, the user's mobile phone 5 has been registered, and each of the user database 8 and the mobile phone's 5 memory 16 have stored therein corresponding shared information 9. In this embodiment the shared information 9 comprises a public/private key pair to facilitate authentication using a digital signature algorithm. In alternative embodiments, the public and private keys may be derived from the mobile phone's 5 IMEI number.

In the first three steps of the method according to this third embodiment, a user input is received 40 at the authentication server 3, authentication data is generated 41, and the authentication data is received 42 at the mobile phone 5. This first step is equivalent to the first step of the method according to the first and second embodiments, and thus what the user input comprises and how it is received 40 is the same as was described above with reference to the first step shown in FIG. 2. If the authentication server 3 determines that the user input is invalid, e.g. if it does not correspond correctly to any of the records in the user database 8, the first step will be repeated. On the other hand, if the user input is valid the method proceeds to the second step which is equivalent to the second method step according to the first embodiment, and thus the authentication data is generated 41 in the same way as was described above with reference to the second step shown in FIG. 2. Alternatively, the authentication data may be generated 41 as was described with reference to the second step shown in FIG. 3. The third step is equivalent to the third step of the method according to the first and second embodiments, and thus how the authentication data is communicated from the authentication server 3 and received by the mobile phone 5 is the same as was described above with reference to the third step shown in FIG. 2.

The encryption module 15 then, in response to receipt of the authentication data, generates 43 response data in accordance with Algorithm B3. In this embodiment, Algorithm B3 is the DSA digital signature algorithm, which is used to generate a digital signature by signing the received authentication data with a private key that is, or is derived from, the shared information 9 retrieved from stored in memory 16. The generated response data thus comprises the generated digital signature.

In the fifth method step according to this third embodiment, the response data is received 44 at the authentication server 3. This step is equivalent to the fifth step of the method according to the first embodiment, and thus how the response data is communicated from the mobile phone 5 and received by the authentication server 5 is the same as was described above with reference to the fifth step shown in FIG. 2.

In response to receipt 44 of the response data, the encryption module 11 generates 45 verification data from the generated 41 authentication data in accordance with Algorithm C3. The verification data is generated using the signature received in the response data and a public key that is, or is derived from, the shared information 9 retrieved from the user database 8. In this embodiment, Algorithm C3 is the DSA digital signature verification counterpart to Algorithm B3.

At the penultimate step of the method according to the third embodiment, the authentication module 12 compares 46 the signature received in the response data with the verification data generated 45 by the authentication module 12. If the two are identical the authentication server 3 authenticates 47 the user and grants access to the secure services; otherwise access is denied and the method is repeated from the point at which the authentication server 3 generates 41 authentication data.

The above description of the embodiments refers to specific block-encryption algorithms and digital signature algorithms, but it will be appreciated that in alternative embodiments any suitable encryption algorithms could be used in their place. For example, 3DES or a stream cipher such as RC4 or RC5 could be used in place of the AES algorithms, and the elliptic curve analogue of the DSA algorithm could be used in its place. Further, it will be appreciated that the second and third embodiments could be combined such that forward and inverse ciphers are used to generate the authentication data and the response data respectively, and the DSA algorithms are used to include a digital signature in the authentication data and to verify the digital signature.

In each of the embodiments described above, the method is performed between the authentication server 3 and the mobile phone 5. It will be appreciated that the methods also apply to gaining access to a standalone computer, wherein all of the method steps performed at the authentication server are performed within the standalone computer.

In addition, while the authentication server 3 has been described to comprise various components, it will be appreciated that these components may in fact reside on separate hardware. Thus the application server 3 described above may in fact be a network of interconnected servers, each performing one or more of the respective steps of the methods described above.

Reference has been made to formatting generated authentication data for communication to the mobile phone 5, by generating an image and packetizing it for communication e.g. over the network 4. It will be appreciated that an HTML description of the image may be generated using PHP, the HTML description causing a web browser on the terminal 2 to render the image on its VDU.

What is claimed:

1. A system for authenticating access by a user to a remote computer comprising:
A first user computer operatively connected to a data network, said first user computer programmed to receive a challenge data object and to transmit a response data input by said user;
A server, said server operatively connected to the first user computer over said data network, said server programmed to transmit a challenge data object to said first user computer and receive from said first user computer a response data;
A second user computer, said second user computer containing a unique identifying data, said second user computer programmed to receive the challenge data object input by a user and using said unique identifying data, to calculate and output said response data.

2. The system of claim 1 where the server is comprised of data storage containing the unique identifier and is further programmed to calculate a comparison response data using said challenge data object and the stored unique identifier and to compare said received response data to said comparison response data.

3. The system of claim 1 where the challenge data object is an alphanumeric string.

4. The system of claim 1 where the challenge data object is an image.

5. The system of claim 1 where the challenge data object is a bar-code.

6. The system of claim 1 where the challenge data object is a sound.

7. The system of claim 1 where the unique identifier is a hash of a data object unique to the user.

8. The system of claim 7 where the data object unique to the user is one of: a telephone number or a mobile device hardware identifying number.

9. The system of claim 7 where the server is further comprised of a data structure containing user name and password unique to the user that is associated with said data object unique to said user.

10. A method of securing access to a remote server comprising:
Transmitting to a first user computer a challenge data object
Transmitting to a second user computer data comprising program code that when executed, performs the step of calculating a response data using a unique identifying data and said challenge data object causing the output of said response data;
Receiving from said first user computer said response data;
Verifying that said received response data correctly corresponds to said transmitted challenge data object.

11. The method of claim 10 where the unique identifying data is contained with the data comprising the program code;

12. The method of claim 11 where the unique identifying data is derived from the hardware of the second user computer.

13. The method of claim 10 where the first user computer is a personal computer attached to the Internet and the second user computer is mobile telephone.

14. The method of claim 10 where the challenge data object is an alphanumeric string.

15. The method of claim 10 where the challenge data object is an image.

16. The method of claim 10 where the challenge data object is a bar-code.

17. The method of claim 10 where the challenge data object is a sound.

18. The method of claim 10 where the unique identifier is a hash of a data object unique to the user.

19. The method of claim 18 where the data object unique to the user is one of: a telephone number or a mobile device hardware identifying number.

20. A system comprised of one or more computers that together perform the steps of claim 10.

21. A method for authenticating access by a user to a remote computer, said method being executed on a user's computer comprising:
Retrieving from memory a challenge data object;
Retrieving from memory a unique identifying data;
Calculating a response data;
Causing an output of the response data.

22. A method for authenticating access by a user to a remote computer comprising:
Retrieving a unique identifying data associated with said user;
Inserting said unique identifying data into a data object comprising a computer program that, when executed, performs the steps of claim 21;
Transmitting said data object comprised of said unique identifying data and said computer program.

23. The method of claim 22 further comprising:
Transmitting a challenge data object to a first computer operated by said user;
Receiving a response data calculated by operation of the transmitted program on a second computer operated by said user;
Verifying that the received response data correctly corresponds to the transmitted challenge data object.

24. A method for authenticating access by a user to a remote computer comprising:
Receiving a challenge data object r;
In response to receipt of the challenge data object, using a predetermined unique identifier shared with the remote computer to calculate a first set of locations in the challenge data object to extract data therefore;
Extracting data from the challenge data object at the calculated locations;
Generating response data in dependence on the extracted data.

25. The method of claim 24 where the receiving step is comprised of one of image capture, sound capture, input of alphanumeric text.

26. The method of claim 24 where the receiving step is the operation of a computer user interface by the user.

27. The method of claim 24 further comprising replacing the first set of locations with a second set of locations, said second set of locations calculated in dependency on the values of the first set of locations.

28. The method of claim 1 where the first user computer and second user computer are two processes executing on the same hardware device.
